(19) United States
(12) Patent Application Publication
(10) Pub. No.: US 2017/0211280 A1
(43) Pub. Date: Jul. 27, 2017

(54) BUILDING PANEL

(71) Applicant: Sherman M. Hubbard, Lincoln, MI (US)

(72) Inventor: Sherman M. Hubbard, Lincoln, MI (US)

(21) Appl. No.: 15/401,163

(22) Filed: Jan. 9, 2017

Related U.S. Application Data
(60) Provisional application No. 62/338,192, filed on May 18, 2016.
(60) Provisional application No. 62/338,211, filed on May 18, 2016.
(60) Provisional application No. 62/287,536, filed on Jan. 27, 2016.

(51) Int. Cl. E04F 13/08; B32B 3/30; B32B 13/04; E04F 13/072; B32B 5/20

(52) U.S. Cl. CPC E04F 13/0875; E04F 13/0869; E04F 13/0871; E04F 13/072; B32B 5/20; B32B 13/045; B32B 3/30; B32B 2266/0228; B32B 2307/304; B32B 2607/00

(57) ABSTRACT

A building panel in the form of a sheet having a front side and a rear side and constructed of a thermal insulating material, such as foam. The front side has a non-planar profile simulating wood siding which is covered with a cementious material and optionally painted. A plurality of spacers protrude outwardly from the rear side of the panel to create a drainage plane between the building and the panel.

### CROSS-REFERENCE TO RELATED APPLICATIONS

This application claims priority to U.S. patent application Ser. No. 62/338,192, filed on May 18, 2016 and U.S. Patent Application No. 62/338,211, filed on May 18, 2016, and U.S. Patent Application No. 62/287,536, filed on Jan. 27, 2016.

### BACKGROUND OF THE INVENTION

I. Field of the Invention

The present invention relates generally to construction materials and, more particularly, to a siding panel for buildings.

II. Description of Related Art

In the construction business, homes, buildings, and the like are oftentimes constructed by first assembling a wooden frame which defines the shape of the building. Oftentimes, the wooden frame is constructed from 2×4 or 4×6 lumber.

After the building frame is constructed, the outside of the building frame is typically covered with siding of some sort or another. The siding typically is constructed of wood, fiberglass, or other synthetic materials.

The previously known siding, however, provides very little, if any, thermal insulation for the building. This is particularly disadvantageous in view of the ever increasing fuel heating costs.

### SUMMARY OF THE PRESENT INVENTION

The present invention provides a building panel which overcomes the disadvantages of the previously known building panels.

In brief, the building panel of the present invention comprises a sheet constructed of thermal insulating material, such as foam. Preferably, the sheet is sized 2 feet by 4 feet, although any other size may be used without deviation from the spirit or scope of the invention.

Each sheet has a front side which spaces outwardly from the building and a rear side which is attached to the building frame in any conventional fashion, such as by nailing, adhesive, and the like. Furthermore, the front or outwardly facing side of the sheet is configured in the form of conventional building sidings of the type formed by overlapping elongated strips of wood siding. As such, the outwardly facing side of each sheet exhibits a non-planar profile.

After the sheets are secured to the outside of the building frame by nails, adhesive, or the like, the outwardly facing sides of the panels are covered by a cementious material. After the cementious material has set, the cementious material may optionally be painted or otherwise colored for the desired color of the outside of the building.

Preferably, the inside of each sheet, i.e. the side of the sheet facing the building frame, includes a plurality of spaced apart spacers which protrude outwardly from the sheet. The spacers thus create a drainage plane along the rear side of the sheet which facilitates the removal of moisture and any entrapped water behind the sheet.

The building panel of the present invention thus provides an outer appearance of a building structure covered by overlapping shingles. However, unlike the previously known building sidings, the thermal insulating material adds to the thermal insulation for the building thus conserving energy and reducing heating costs. Furthermore, since the cementious material is also provided between adjacent panels, the completed siding is essentially sealed from air flow thus further reducing any heating loss from the building.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational partially fragmented view illustrating an exemplary use of the present invention;

FIG. 2 is a front plan view illustrating a preferred embodiment of the present invention;

FIG. 3 is a rear plan view illustrating the rear side thereof;

FIG. 4 is a view taken substantially along line 4-4 in FIG. 2 and enlarged for clarity;

FIG. 5 is a view similar to FIG. 2, but illustrating a second preferred embodiment of the present invention;

FIG. 6 is a view taken substantially along line 6-6 in FIG. 5; and

FIG. 7 is a view of a roller which may be used to shape the siding.

### DETAILED DESCRIPTION OF A PREFERRED EMBODIMENT OF THE PRESENT INVENTION

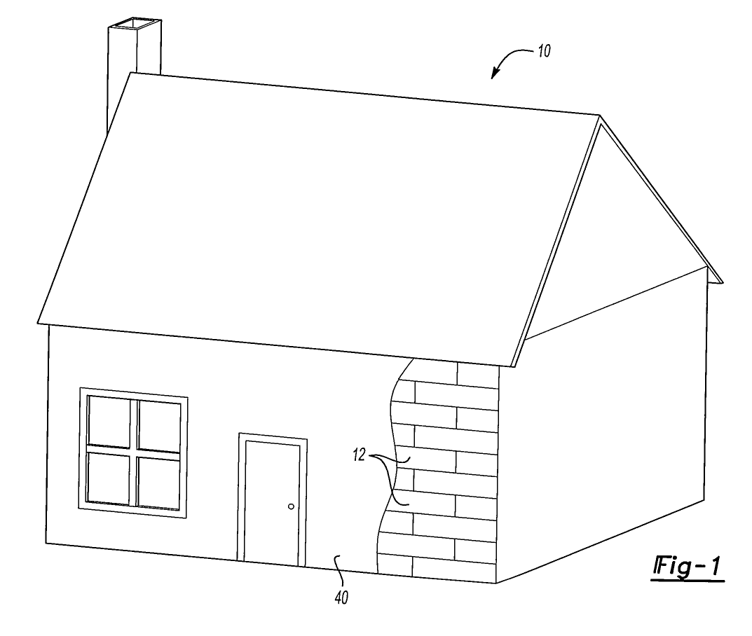

With reference first to FIG. 1, an exemplary building 10 is illustrated. At least a portion of the outside surface of the building 10 is covered by siding panels 12 in accordance with the present invention.

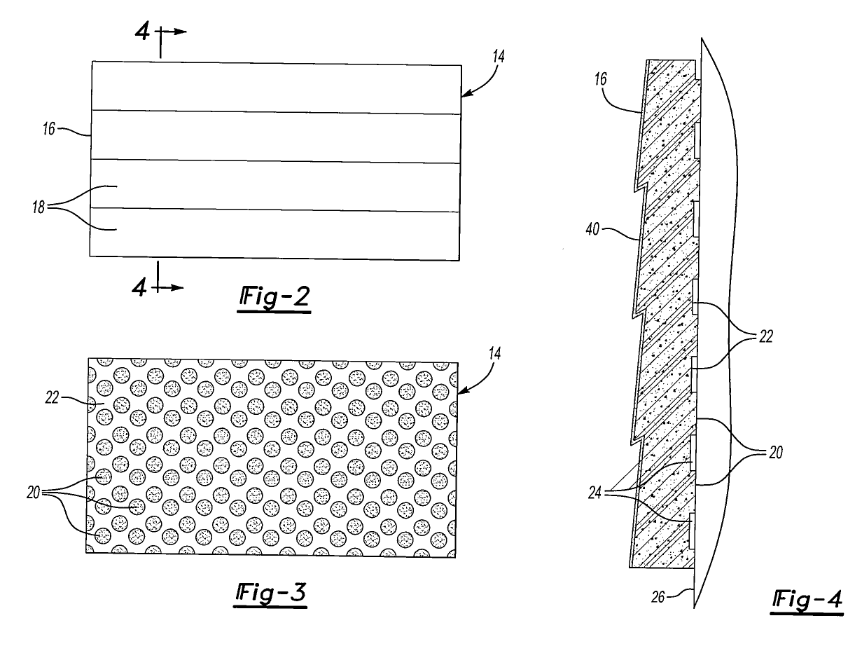

With reference now to FIGS. 2-4, one siding panel 14 is there shown in greater detail. The siding panel 14 is preferably 2 feet by 4 feet in height and width and a thickness less than a few inches. However, building panels 14 may be of different sizes without deviation from the spirit or scope of the invention.

The building panel 14 is formed from an insulating material, such as Styrofoam or other expanded foam. As best shown in FIGS. 2 and 4, a front side 16 of the building panel 14 is non-planar in shape and, instead, includes a non-planar profile which simulates the appearance of conventional building siding. As shown in FIGS. 2 and 4, the simulated building panel includes overlapping and horizontally elongated strips 18.

With reference now to FIGS. 3 and 4, a plurality of spacers 20 protrude outwardly from a rear side 22 of the panel 14. These spacers 20 are illustrated as circular in shape in FIG. 3 but, in practice, may take any geometric shape. The spacers 20, furthermore, form an open channel 24 (FIG. 4) between the rear side 22 of the panel and an outer wall 26 of the building 10. Consequently, any water or moisture that may be entrapped between the panel 14 and the building wall 26 is able to flow downwardly and outwardly from the drainage spaces 24 between the panel 14 and the building wall 26.

Referring again to FIG. 1, in practice the building panels 14 are secured to the outer wall 26 of the building 10 in any conventional fashion, such as by adhesive, screws, nails, etc. In doing so, both the upper and lower edges, as well as the side edges of each panel, preferably abut against the adjacent upper, lower, or side edges of the adjacent panels 14.

Still referring to FIG. 1, after the panels 12 are secured to the building wall 10, the outwardly facing surfaces 14 of the panels 12 are covered by a cementious material 40 which is then allowed to cure. The cementious material 40 thus covers and hides the seams between the adjacent panels 12. If desired, a tape, such as a fiberglass tape, may also be applied across each junction between adjacent panels 12 prior to applying the cementious material.

With reference now to FIG. 7, a profiled roller 30 having an outside surface 32 which simulates a wood grain may optionally be rolled over the cementious material before the cementious material has set. The patterned roller 30 thus enables the paneling to exhibit an appearance similar to woodgrain siding. Furthermore, after the cementious material has set, if desired, the cementious material may be covered by painting.

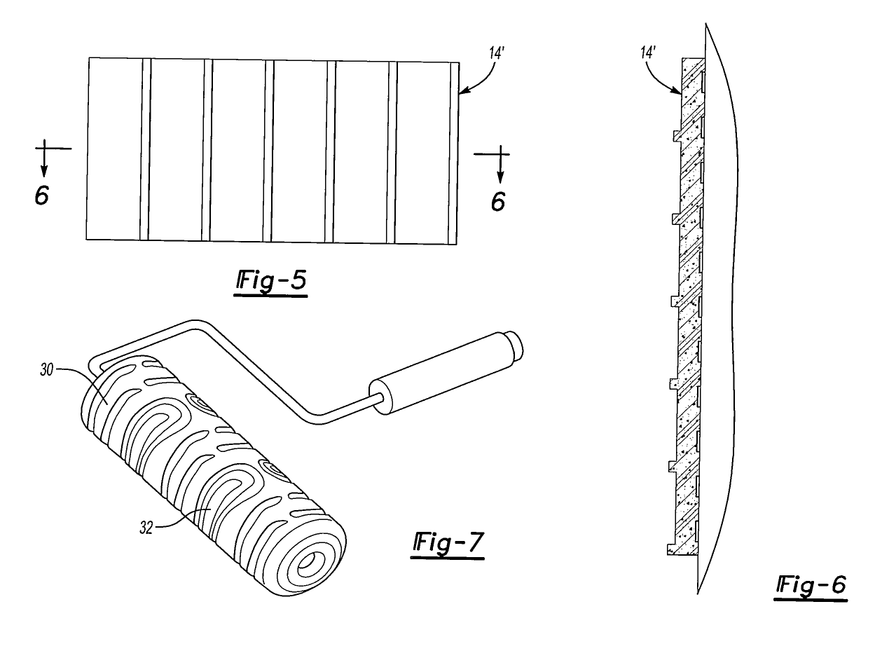

It will be understood, of course, that the siding illustrated in FIGS. 2-4 is by way of example only. Instead, other patterns, such as a vertical wood pattern illustrated in FIGS. 5 and 6, by way of example only, may form the outwardly facing side of the panel after installation.

A primary advantage of the present invention is that the panel is not only relatively inexpensive to manufacture and install, but also adds a significant R factor insulating value which varies, of course, depending upon the thickness of the panel 12. Furthermore, since adjacent panels 12 are sealed together against wind drafts, heat loss from the building through convection is even further reduced.

Having described my invention, many modifications thereto will become apparent to those skilled in the art to which it pertains without deviation from the spirit of the invention as defined by the scope of the appended claims.

I claim:

1. A building panel comprising:
a sheet having a front side and a rear side, said sheet being constructed of a thermal insulating material,
said front side having a non-planar profile which simulates building siding.

2. The invention as defined in claim 1 and comprising a coating which overlays said front side of said sheet.

3. The invention as defined in claim 1 wherein said insulating material comprises a foam.

4. The invention as defined in claim 3 wherein said foam comprises a polystyrene foam.

5. The invention as defined in claim 4 wherein said foam is extruded.

6. The invention as defined in claim 4 wherein said foam is expanded.

7. The invention as defined in claim 1 and comprising a plurality of spaced apart spacers protruding outwardly from said rear side of said sheet, said spacers forming a drainage plane along said rear side of said sheet.

8. The invention as defined in claim 2 wherein said coating comprises a cementious material.

9. The invention as defined in claim 8 and comprising a pattern formed in said coating.
